(19) United States
(12) Patent Application Publication
(10) Pub. No.: US 2020/0233872 A1
(43) Pub. Date: Jul. 23, 2020

(54) SYSTEM AND METHOD FOR DISCOVERING SYNERGISTIC COMPANIES

(71) Applicant: International Business Machines Corporation, Armonk, NY (US)

(72) Inventors: John G. Vergo, Yorktown Heights, NY (US); Anuradha Bhamidipaty, Yorktown Heights, NY (US); Justin Platz, Yorktown Heights, NY (US); Alan M. Webb, Yorktown Heights, NY (US); Jeffrey Owen Kephart, Yorktown Heights, NY (US); Danny Soroker, Yorktown Heights, NY (US); Daniel M. Gruen, Cambridge, MA (US); Julie Macnaught, Southbury, CT (US); Michael Abraham Tanenblatt, Yorktown Heights, NY (US); Siva Sankalp Patel, Yorktown Heights, NY (US)

(21) Appl. No.: 16/251,464

(22) Filed: Jan. 18, 2019

(51) Int. Cl. G06F 16/2457; G06Q 10/06

(52) U.S. Cl. CPC G06F 16/24578; G06Q 10/06393

(57) ABSTRACT

A similarity determination method, system, and computer program product, including using a description of companies for making a list of query entities, calculating a set of similar companies for each company on the list of query entities, employing a voting scheme to rank the results of the calculating, ordering a final set of the results based on the voting scheme and presenting them back to the user as a first ranked list, iteratively repeating the calculating by adding a second set of new companies and recalculating a second ranked list of recommended companies based on the updated query list, combining the first ranked list and the second ranked into a single set of companies of a combined list while remembering which of the first ranked list and the second ranked list from which each company originated, and visualizing the combined list based on which original list the companies came from. The technique can be extended to an arbitrary number of lists.

### BACKGROUND

The present invention relates generally to a similarity determination method for finding companies, and more particularly, but not by way of limitation, to a system, method, and recording medium for finding a set of companies (i.e., entities) that are most similar to a plurality of target descriptions (i.e., queries) of companies by evaluating text similarity between the query text and all of the companies in the search repository and obtaining a ranked list of companies.

There is substantial conventional techniques in the area of search that can and is being applied to company search. Keyword search is well known. More recently, semantic word embeddings such as GLoVE, Word2Vec and Doc2Vec have made strides in semantic representations of words and documents. These techniques are frequently applied to the task of finding similar words and/or documents. Doing so in the company search domain is straight forward.

### SUMMARY

The invention is novel in that the invention addresses the task of finding companies that satisfy multiple, complex natural language queries from different sources simultaneously.

In an exemplary embodiment, the present invention can provide a computer-implemented search and synergy determination method, the method including building a corpus of company information which includes a combination of textual information about the company and structured information about the company, using multiple query entities, calculating a set of similar companies for each company on the list of each query entities, employing a voting scheme to rank the results of the calculation, ordering a final set of the results based on the voting scheme and presenting them back to the user as a first ranked list, iteratively repeating the calculation by adding a second set of new companies and recalculating a second ranked list of recommended companies based on the updated query list, combining the first ranked list and the second ranked into a single set of companies of a combined list while remembering which of the first ranked list and the second ranked list from which each company originated, performing a dimensionality reduction of the companies on the combined list and visualizing the combined list while indicating the original list the companies came from.

Another exemplary embodiment starts with multiple documents, each of which provides a detailed description of a company that is being sought (i.e. a query document). Each query document is used to generate a set of candidate companies. As in the previous embodiment, a voting scheme is employed to combine and rank the results, followed by dimensionality reduction and visualization.

The preferred embodiment we present uses t-SNE as the dimensionality reduction and visualization techniques, but other embodiments such as UMAP are possible.

One or more other exemplary embodiments include a computer program product and a system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a similarity and synergy determination method 100;

FIG. 2 exemplarily depicts a t-SNE visualization showing companies and recommendations for three lists by implementing the method 100 according to an embodiment of the present invention;

FIG. 3 exemplarily depicts a force directed graph showing similar companies to a single company by implementing the method 100 according to an embodiment of the present invention;

FIG. 4 exemplarily depicts an overview of one embodiment of the present invention;

FIG. 5 depicts a cloud computing node 10 according to an embodiment of the present invention;

FIG. 6 depicts a cloud computing environment 50 according to an embodiment of the present invention; and

FIG. 7 depicts abstraction model layers according to an embodiment of the present invention.

### DETAILED DESCRIPTION

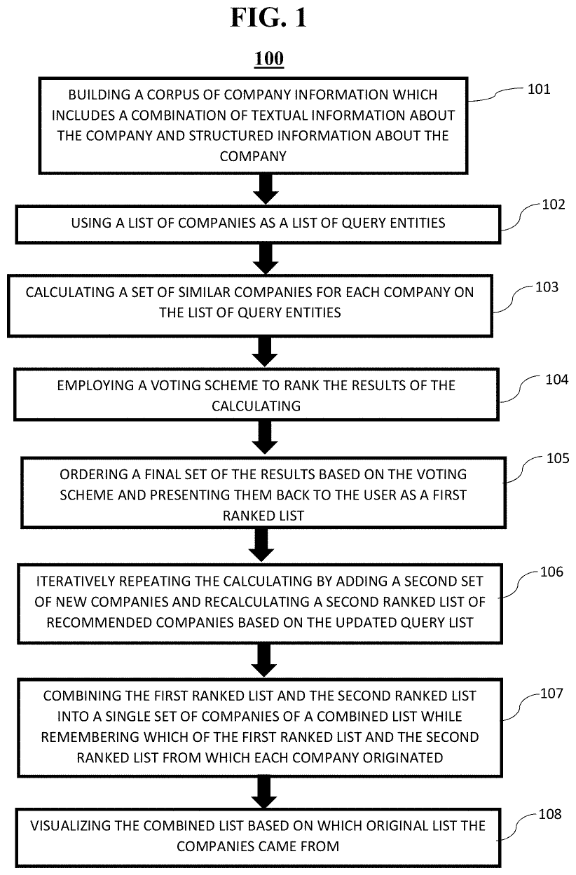

The invention will now be described with reference to FIG. 1-7, in which like reference numerals refer to like parts throughout. It is emphasized that, according to common practice, the various features of the drawing are not necessarily to scale. On the contrary, the dimensions of the various features can be arbitrarily expanded or reduced for clarity.

With reference now to the example depicted in FIG. 1, the similarity determination method 100 includes various steps for using a dimensionality reduction technique (e.g., t_SNE or UMAP) to determine how companies can satisfy the requirements of multiple parties when searching for a company to purchase.

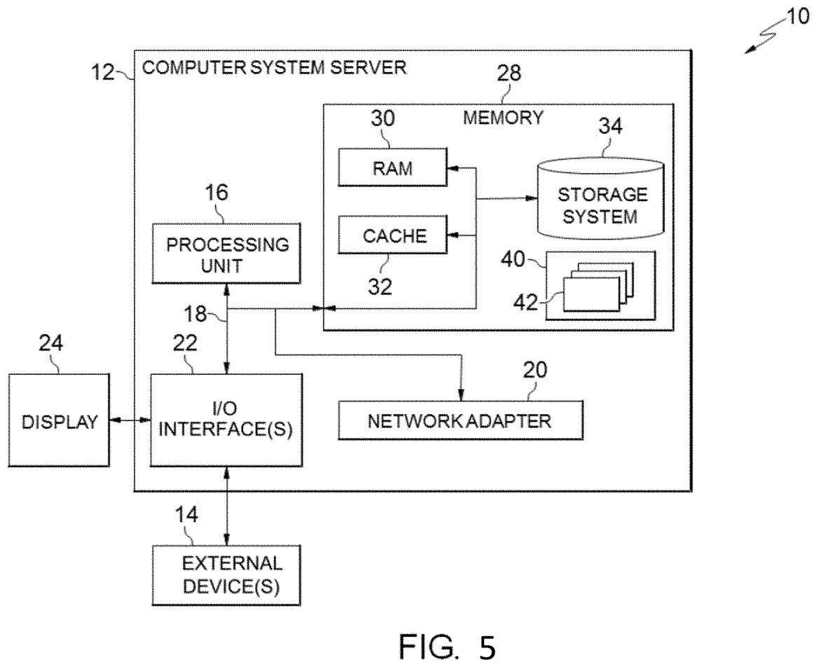

As shown in at least FIG. 5, one or more computers of a computer system 12 according to an embodiment of the present invention can include a memory 28 having instructions stored in a storage system to perform the steps of FIG. 1.

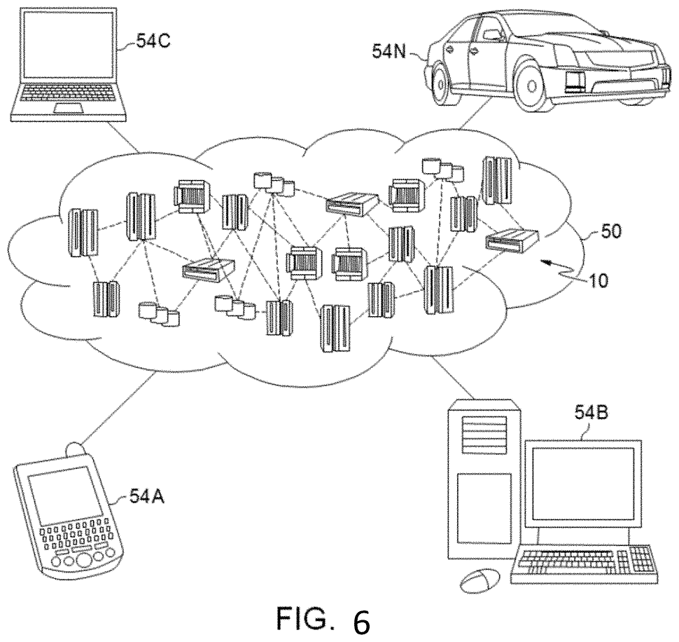

Although one or more embodiments (see e.g., FIGS. 5-7) may be implemented in a cloud environment 50 (see e.g., FIG. 6), it is nonetheless understood that the present invention can be implemented outside of the cloud environment.

With reference generally to FIGS. 1-4, the invention may find a set of companies (i.e., entities) that are most similar to target description (i.e., query) of a company by evaluating text similarity between the query text and all of the companies in the search repository and obtaining a ranked list of companies. The invention may process user generated queries that describe a target company in descriptive text and/or structured attributes and normalizing the descriptive text by removing (i.e., clean-up) text that does not contribute to describing essential functions of the company. And, the invention may calculate the text similarity between the query text and all of the companies in the search repository using term frequency-inverse document frequency plus cosine similarity (alternatively, Word2Vecec, GLoVe, Doc2Vec, etc. may be used for the word embedding) and measuring scores based on structured attributes in the query and derived attributes for processing the text similarity, yielding a re-ranked list of recommended companies.

That is, the similarity calculations of the invention are based on an assumption that similar companies have overlapping key words in their descriptions or that the words used in the descriptions have similar meaning (i.e. semantics).

It is noted that “synergy” as discussed herein is defined as finding a single company that meets the goals of multiple parties (e.g. business units) within the acquiring company.

Further, it is noted that although the invention is described in the domain of companies, the invention is not limited thereto and can be embodied for similarities between people, recipes, etc.

The similarity between two companies can be calculated by preprocessing each description to filter out unimportant text, stop words, and boilerplate phrases. The names of specific companies and locations are removed, which generally do not contribute to functional similarity. These words and phrases are identified with a publicly available Natural Language Understanding service. The remaining text is then lemmatized and this process is repeated for the description of all companies in the database. A term frequency-inverse document frequency (tf-idf) model is built using the preprocessed descriptions. The invention is not limited to tf-idf model but can be operated using any word embedding technique that can cluster words with similar meaning in vector space such that two descriptions with similar meaning using different words can be identified. In a preferred embodiment, a tf-idf technique is utilized. Each company can be represented by a row in the tf-idf matrix. A tf-idf model has various parameters such as the minimum number of documents a token must appear in for it to be considered in the vocabulary, mindf, and similarly, the maximum number of documents a token must appear in to consider it important, maxdf. A surrogate metric to evaluate the performance of the tf-idf model tunes these parameters and is used to choose the best parameters for the model.

The similarity between two companies is defined as the cosine of their tf-idf vectors.

sim(company_{A},company_{B})=cos(tf-idf_{A},tf-idf_{B})

To find the n most similar companies to company A, a similarity between company A and all companies in the tf-idf matrix is found. This can be done with a matrix multiplication of:

sim(company_{A},all companies)=cos(tf-idf_{A},tf-idfₘₐₜᵣᵢₓ)

This gives a column of all similarity scores, from which the top n corresponding companies are returned.

An evaluation metric is defined to measure the performance of the tf-idf model, or generally, a word embedding technique used by the invention. In one embodiment, ground truth data is needed. To form the ground truth, 3000 pairs of company descriptions are annotated by assigning each pair a rank of “1” (strong), “2” or “3” (weak). To evaluate the performance of the model, the similarity scores are calculated from the model (as described above) for all 3000 pairs and then calculated the Spearman's rank correlation coefficient. This is iterated over several values of mindf and maxdf, picking the values that resulted in the best Spearman score.

Finding the top companies that match a list L of companies is done in three steps. For each company in L, similar companies are found, each with its similarity score. A similarity algorithm is employed based on company description text. The similarity techniques are deployed that also take into account structured data, such as number of employees, revenue and location (i.e., company information includes a combination of descriptive (textual) information about the company and structured information about the companies).

Then, for each matching company found in step one, its aggregate score is determined, based on the individual similarity scores obtained in step 1 Each possibly matching company mi now has an array of similarity scores, Si, one for each company in the input list L. An aggregation function is applied to Si to produce the aggregate score aggi for mi. Three aggregation schemes can be used such as Borda, Average, and Best. Average and Best are derived directly from the array or scores, where Best uses the highest score and Average uses the average of all scores. Borda is a voting scheme based on the ranks of companies on the match lists: each company in the original list ranks its matches, and the Borda count of a matched company is the sum of all its ranks, such that lower is better.

And, the matching companies are sorted by their aggregate scores, aggi, and the top ones are returned. The initial list input by the user can be used to tune the weights of the similarity function to realize a weighted cosine similarity function.

It is noted that the corpus defined above preferably includes a multi-dimensional variable (MDV) of an entity (which is the word embedding vector derived from the textual description of the company) plus structured data about the entity such that they can be combined (e.g., 300 MDV's combined with a number of structured data).

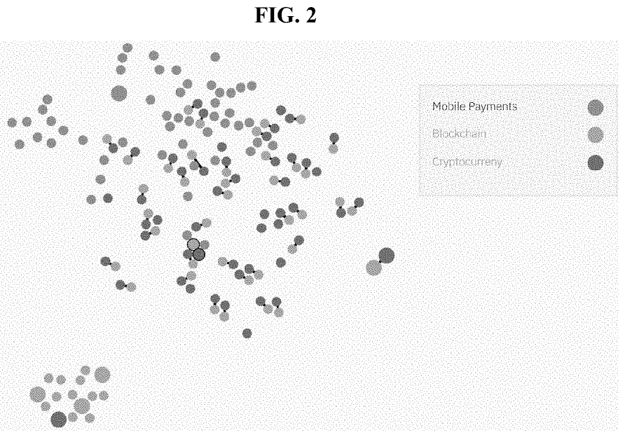

The results of the lists are visualized by maintaining a relationship of similarity in a high-dimensional space mapped to a low-dimensional visualization (e.g., shown in 2-D or 3-D for human consumption). More specifically, to help the user find matching companies of interest based on similarity to one or more lists, a t-SNE based visualization, U-map, dimensionality reduction technique, etc. may be used. In one embodiment using the t-SNE technique, one variant takes the pairwise similarity matrix, converts it to a distance matrix, and uses t-SNE to produce 2-D coordinates, so that companies are positioned closest to the ones most similar. When several lists are provided as input (e.g., as exemplarily shown in FIG. 2), the visualization helps identify matching companies that are similar to more than one list.

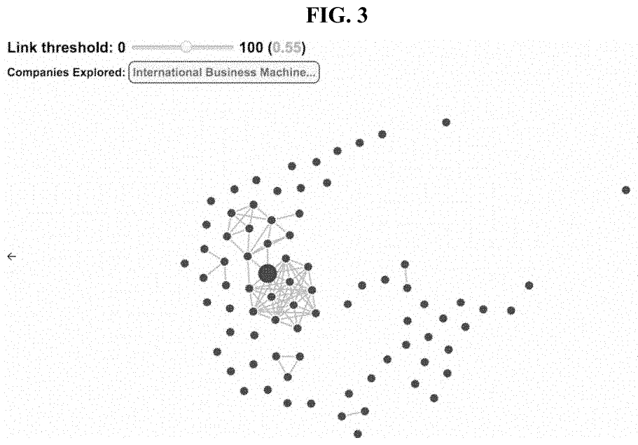

A second variant uses a force-based layout for a graph, in which each company is a node, and two nodes are connected if their similarity is above a given threshold. For example, a threshold slider can be moved from 0 to 1 such that the graph gets sparser, and one can identify neighborhoods and clusters of interest (e.g., as exemplarily shown in FIG. 3).

The implementation uses a back-end service to compute the similarity matrix between all pairs of companies before rendering the graph. By running a simple analytic on the similarity matrix, one can derive a reasonable starting value for the slider. For example, one can target an initial density of 30% by choosing a threshold that is just above 30% of the set of values in the matrix.

Referring back to FIG. 1, in step 101, a corpus of company information is built which includes a combination of textual information about the company and structured information about the company.

In step 102, a list of companies (or description of companies) is used as a list of query entities such that, in step 103, a set of similar companies for each company on the list of query entities is calculated. For example, a list of companies that produce wearable computing technology might consist of Fitbit, Salutron, Jawbone and Runtastic. A result of the similar companies to the companies on the list might include Sensoria, Amiigo, Good Parents and MapMyFitness. The user can control the length of the similarity list. Depending on the number of companies operating in an area, useful list lengths can be more than 100 and determined empirically by the user. In an alternative embodiment, the list length is determined analytically.

In step 104, a voting scheme is employed to rank the results of the calculation.

In step 105, a final set of the results is ordered based on the voting scheme and presenting them back to the user as a first ranked list. Optionally, in step 106, the calculating in step 103 is iteratively repeated by adding a second set of new companies and recalculating a second ranked list of recommended companies based on the updated query list.

In step 107, the first ranked list and the second ranked are combined into a single set of companies of a combined list while remembering which of the first ranked list and the second ranked list from which each company originated. This can be extended to any number of lists

In step 107.5, perform a dimensionality reduction of the companies in the list. In the preferred embodiment, the dimensions are reduced to 2 dimension using t-SNE or UMAP.

In step 108, the combined list (or optionally the one list) is visualized based on which original list the companies came from.

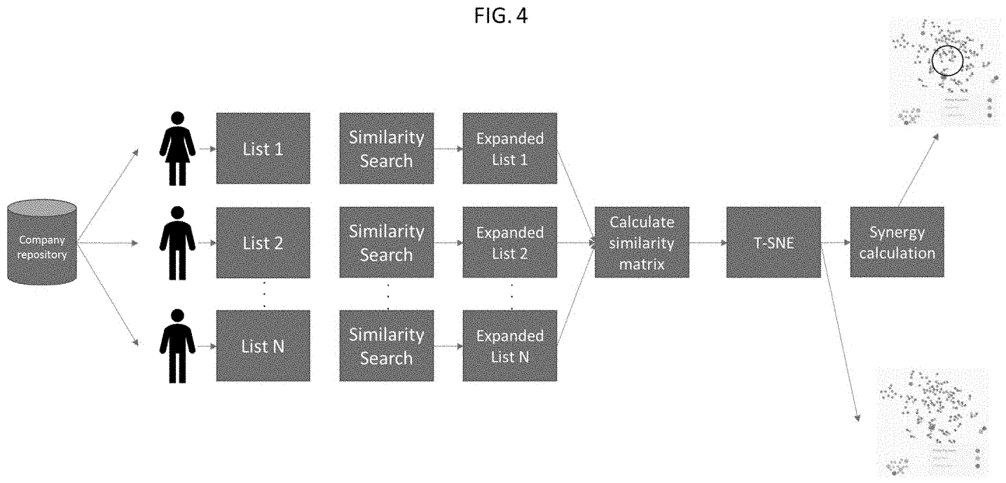

With reference to FIG. 4, FIG. 4 depicts a general flow for multiple user queries and inputs. For example, a user can input multiple lists (List 1, List 2, . . . List N) as a set of entities to query against the company repository. The similarity search between each is compiled and expanded to calculate a similarity matrix between each list and the corpus. Then, the results are visualized using, for example a t-SNE technique. And, a synergy calculation can be performed on the visualized data to show an overlap as a single company that meets the goals of multiple parties (e.g. business units) within the acquiring company.

Exemplary Aspect, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 5, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 5, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 6, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 6 are intended to be illustrative only and that computing nodes 10 and cloud computing environment 50 can communicate with any type of computerized circuit over any type of network and/or network addressable connection (e.g., using a web browser).

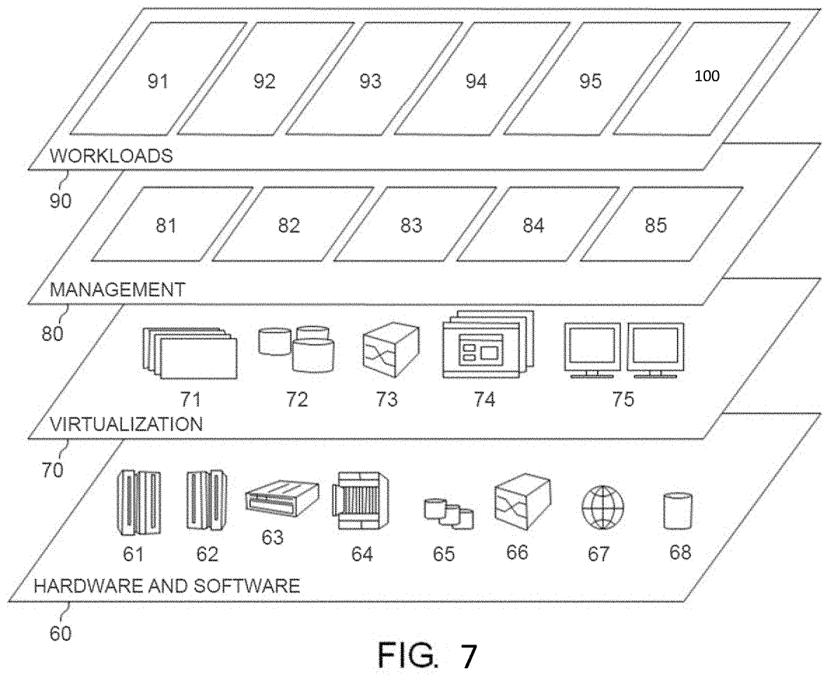

Referring now to FIG. 7, an exemplary set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components.

Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the similarity determination method 100.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented similarity determination method, the method comprising:
building a corpus of company information which includes a combination of textual information about the company and structured information about the company;
using a description of companies for making a list of query entities;
calculating a set of similar companies for each company on the list of query entities;
employing a voting scheme to rank the results of the calculating;
ordering a final set of the results based on the voting scheme and presenting them back to the user as a first ranked list;
iteratively repeating the calculating by adding a second set of new companies and recalculating a second ranked list of recommended companies based on the updated query list;
combining the first ranked list and the second ranked into a single set of companies of a combined list while remembering which of the first ranked list and the second ranked list from which each company originated; and
visualizing the combined list based on which original list the companies came from.

2. The computer-implemented method of claim 1, wherein each list is extended by calculating a different number of similar companies as specified by a user.

3. The computer-implemented method of claim 1, wherein the visualizing visualizes the combined list in two-dimensions or three-dimensions.

4. The computer-implemented method of claim 1, wherein the calculating calculates the similar companies via a word embedding technique.

5. The computer-implemented method of claim 1, wherein the visualizing further performs a synergy calculation to show a single company that meets the goals of multiple companies within the acquiring company.

6. The computer-implemented method of claim 1, wherein the visualizing maintains a relationship of the similarity in a high-dimensional space when mapped to a lower-dimensional space.

7. The computer-implemented method of claim 1, embodied in a cloud-computing environment.

8. A computer program product for similarity determination, the computer program product comprising a computer-readable storage medium having program instructions embodied therewith, the program instructions executable by a computer to cause the computer to perform:
building a corpus of company information which includes a combination of textual information about the company and structured information about the company;
using a description of companies for making a list of query entities;
calculating a set of similar companies for each company on the list of query entities;
employing a voting scheme to rank the results of the calculating;
ordering a final set of the results based on the voting scheme and presenting them back to the user as a first ranked list;
iteratively repeating the calculating by adding a second set of new companies and recalculating a second ranked list of recommended companies based on the updated query list;
combining the first ranked list and the second ranked into a single set of companies of a combined list while remembering which of the first ranked list and the second ranked list from which each company originated; and
visualizing the combined list based on which original list the companies came from.

9. The computer program product of claim 8, wherein each list is extended by calculating a different number of similar companies as specified by a user.

10. The computer program product of claim 8, wherein the visualizing visualizes the combined list in two-dimensions or three-dimensions.

11. The computer program product of claim 8, wherein the calculating calculates the similar companies via a word embedding technique.

12. The computer program product of claim 8, wherein the visualizing visualizes the combined list based on a dimensionality reduction technique.

13. The computer program product of claim 8, wherein the visualizing maintains a relationship of the similarity in a high-dimensional space when mapped to a lower-dimensional space.

14. A similarity determination system, said system comprising:
a processor, and
a memory, the memory storing instructions to cause the processor to perform:
building a corpus of company information which includes a combination of textual information about the company and structured information about the company;
using a description of companies for making a list of query entities;
calculating a set of similar companies for each company on the list of query entities;
employing a voting scheme to rank the results of the calculating;
ordering a final set of the results based on the voting scheme and presenting them back to the user as a first ranked list;
iteratively repeating the calculating by adding a second set of new companies and recalculating a second ranked list of recommended companies based on the updated query list;
combining the first ranked list and the second ranked into a single set of companies of a combined list while remembering which of the first ranked list and the second ranked list from which each company originated; and
visualizing the combined list based on which original list the companies came from.

15. The system of claim 14, wherein each list is extended by calculating a different number of similar companies as specified by a user.

16. The system of claim 14, wherein the visualizing visualizes the combined list in two-dimensions or three-dimensions.

17. The system of claim 14, wherein the calculating calculates the similar companies via a word embedding technique.

18. The system of claim 14, wherein the visualizing visualizes the combined list based on a dimensionality reduction technique.

19. The system of claim 14, wherein the visualizing maintains a relationship of the similarity in a high-dimensional space when mapped to a lower-dimensional space.

20. The system of claim 14, embodied in a cloud-computing environment.
